(19) United States
(12) Patent Application Publication
(10) Pub. No.: US 2015/0278604 A1
(43) Pub. Date: Oct. 1, 2015

(54) Systems, Devices And Methods For Person And Object Tracking And Data Exchange

(71) Applicants: Gary Stephen SHUSTER, Fresno, CA (US); Brian Mark SHUSTER, Vancouver (CA)

(72) Inventors: Gary Stephen SHUSTER, Fresno, CA (US); Brian Mark SHUSTER, Vancouver (CA)

(21) Appl. No.: 14/673,726

(22) Filed: Mar. 30, 2015

Related U.S. Application Data
(60) Provisional application No. 61/972,372, filed on Mar. 30, 2014.

(51) Int. Cl. G06K 9/00; H04N 5/33; G06T 11/60; G02B 27/01; H04N 5/247

(52) U.S. Cl. CPC G06K 9/00671; G02B 27/0101; G02B 27/0172; G02B 27/0189; H04N 5/247; G06T 11/60; H04N 5/33; G02B 2027/0141; G02B 2027/0138; G02B 2027/014

(57) ABSTRACT

Systems, devices and methods for managing information about living beings and/or objects are disclosed. The systems and methods of the present invention comprise operably coupling together at least two Digital Person Devices, gathering data about living beings and/or objects with one or more of the Digital Person Devices, analyzing and/or identifying the data gathered, and sharing at least a portion of the data between one or more of the Digital Person Devices so as to improve qualities and/or the quantity of available data to the devices, and/or to reduce the power, performance and/or bandwidth required by one or more of the Digital Person Devices. In some embodiments, the systems and methods also comprise operably coupling a digital professor device to the Digital Person Devices, wherein the Digital Professor Device manages the gathering of data, and/or the storing, analyzing, identifying and/or exchanging of the gathered data.

### CROSS-REFERENCE TO RELATED APPLICATIONS

This application claims the benefit of U.S. Provisional Patent Application No. 61/972,372 filed Mar. 30, 2014. The text and contents of that provisional patent application are hereby incorporated into this application by reference as if fully set forth herein.

### FIELD OF INVENTION

The subject disclosure generally relates to the field of data processing and management for augmented reality (AR). Specifically, embodiments of the present invention relate to systems, methods and devices to identify and track living beings and objects, and manage, share, and in some instances alter data about the beings and objects consistent with privacy, legal, contractual, policy and/or other restrictions.

### DISCUSSION OF THE BACKGROUND

For the purposes of this specification, the present invention will generally be described in relation to systems, methods and devices to identify and track people and/or objects. However, it should be understood that the invention is not so limited, and may be applied to the collection, identification, analysis, tracking and sharing of data related to any living being or item, whether “real” or “virtual”.

The ability to identify people and objects is a critical requirement for effective augmented reality and extends across almost every implementation or use of AR, from marketing to law enforcement, personal data augmentation to education, personal safety to capacity and resource planning. However, the mere ability to identify people and objects, while a necessary function, is insufficient by itself to fully exploit the potential of AR. Rather, the importance of the people or objects, both objectively and subjectively, their characteristics, and other intelligence about them is critical.

Consider the example of a potentially dangerous animal. Imagine that an AR system utilized by a mother taking her children to a park correctly identifies a purebred “Pit Bull” without a leash or other constraining element, such as a fence, together with a dozen people. Mere identification of the people, the dog, and other environmental elements is insufficient to give rise to proper threat assessment.

A similar problem arises with humans. Consider identification of a human being in a crowd holding a sword. Mere identification of the human being, even by name, is insufficient to give rise to a proper threat assessment. The person may be a performer on the way to a sword-swallowing demonstration or may be in a dangerous mental state and ready to inflict harm.

The problem also persists outside of the area of threat assessment. Consider identification of a person in a coffee shop who is a friend of a friend (perhaps according to a cross reference to a business networking system such as LinkedIn®). Mere identification of the person is insufficient to determine if approaching the person, even to say hello, is appropriate or would be well received.

A common challenge, unsolved prior to the instant invention, is the ability to not only track persons and objects, but to manage knowledge about those persons and objects in a manner that is persistent, and consistent with restrictions on information associated with those persons or objects. The capability to dynamically share data, process tasks, track tasks and retrieve data in a manner that is in compliance with privacy, legal, and other requirements, prior to the instant invention, has been lacking.

The instant invention solves each of these problems. By tracking people and objects, establishing data persistence about the people and objects, and exchanging such information, highly current and relevant data, in some cases together with data not directly available to the user of the AR device, become available and provide meaningful and actionable information far in excess of what mere identification and tracking alone are able to obtain.

An additional problem solved by the instant invention is the incomplete and/or inadequate tracking and identification caused by the limitations in computational, networking, and sensor capability and other limitations to existing devices. It is likely that improvements will occur in technologies such as triangulation, GPS signal reception, computerized object identification, RFID, and other modalities for object location or identification. Such advancements will improve the ability to identify and locate real world objects (whether those objects have been designed to interact with such technologies or not).

However, advancements will create significantly increased demands for power, bandwidth, storage, and other elements necessary to utilize such technologies. It is unlikely that improvements to battery energy density, data compression, storage density, and other factors that limit the use of such technologies will take place rapidly enough to enable each device to gather sufficient data about proximate real world items to meet the user needs. It is likely that the capability of existing devices, even with significant improvements, working alone, will not be sufficient to meet the tracking, identification, and data acquisition needs of AR.

Similarly, there are certain items that users may desire to keep secret or make detectible to or accurately identifiable by only devices operated by authorized persons or entities. It is also important to note that not all devices will have all sensory devices available to them, and not all sensory devices will be located in a position that is compatible with detection of certain environmental elements.

Consequently, there is a strong need for systems, devices and methods that manage information about living beings and objects, and do so persistently, and consistent with privacy, legal, contractual, policy and/or other restrictions, while improving the quality and quantity of available data, and/or reducing the power, performance and/or bandwidth requirements. To this end, it should be noted that the above-described deficiencies are merely intended to provide an overview of some of the problems of conventional systems, and are not intended to be exhaustive. Other problems with the current state of the art and corresponding benefits of some of the various non-limiting embodiments may become further apparent upon review of the following description of the invention.

### SUMMARY OF THE INVENTION

Embodiments of the present invention relate to systems, methods and devices for managing information about living beings and objects, tracking and identify persons and objects, and managing, sharing, and in some instances altering data about the persons and objects consistent with privacy, legal, contractual and policy restrictions. Other methods, devices and systems for accomplishing similar objectives are disclosed in the co-pending application, Ser. No. 14/673,703, also entitled Systems, Devices and Methods for Person and Object Tracking and Data Exchange, filed concurrently by the inventors hereof, which is hereby incorporated by reference into this application as if fully set forth herein.

Devices belonging to different people, groups or organizations may have different capabilities and access to different information. Even multiple devices in the custody of a single person may have these differences. Embodiments of the present invention allow devices to gather, share and maintain data in a way that reduces the performance, power and bandwidth requirements for any specific device while improving the universe of data available to each device. Utilizing aspects of the present invention whereby devices that receive shared data are able to retain the data after the devices that originally gathered or provided the data leave a venue (a real world or a virtual group), embodiments of the present invention create an on-demand perceptual computing cloud tied to a specific venue, purpose and/or affinity group.

In a typical setting, hundreds of devices may be in a given venue. Some of those devices may be operated by people who are associated with each other, such as those who are members of the same family or people associated with public safety police (e.g., police or emergency medical personnel). The devices may exchange authentication data to determine what kinds of information they can share and/or retain, and the restrictions, if any, on further sharing. For example, devices associated with law enforcement may share all data with each other, and receive (but not share) data with devices associated with government agencies. By sharing data, each device substantially reduces the amount of ambient data it needs to collect and/or analyze in order to fully identify and/or understand the elements in its environment.

In one embodiment, the invention relates to a method of managing information about living beings and/or objects, the method comprising (a) operably coupling together at least two digital person devices, (b) gathering data about one or more living beings and/or objects with one or more of the digital person devices, (c) analyzing and/or identifying the data gathered, and (d) sharing at least a portion of the data between one or more of the digital person devices so as to improve qualities and/or quantity of available data to, and/or reduce power, performance and/or bandwidth required by one or more of the digital person devices.

The invention also relates to an additional method of managing information about living beings and/or objects, the method comprising (a) operably coupling a digital professor device to at least two digital person devices, (b) gathering data about one or more living beings and/or objects, (c) storing the gathered data, (d) analyzing and/or identifying the gathered data, and (e) exchanging the gathered data with the at least two digital persons and/or other devices, wherein the digital professor device manages gathering data and/or storing, analyzing, identifying and/or exchanging the gathered data.

The invention further relates to a system for managing information about living beings and/or objects, the system comprising (a) at least two digital two digital person devices operably coupled to each other, (b) at least one digital professor device operably coupled to the digital person devices, the digital person devices and/or the digital professor device(s) configured to gather, store, analyze and/or exchange data about one or more living beings and/or objects, and wherein the digital professor device is configured to manage the gathering, storing, analyzing, identifying and/or exchanging of the data.

In yet another embodiment, the invention relates to an apparatus for imaging through opaque barriers, the apparatus comprising (a) at least one imaging device located behind an opaque barrier, (b) at least one receiving device located in front of the opaque barrier, wherein imaging device(s) and the receiving device(s) are operably coupled to a data processing device, wherein the data processing device analyzes data from the imaging device(s), and displays at least a portion of the data on the receiving device(s), wherein the display of data overlays a view of at least a portion of the opaque barrier in a manner that makes it appear to users of the receiving device(s) as if the opaque barrier is at least partially transparent with regard to at least one object located behind the opaque barrier.

Embodiments of the present invention advantageously provide methods, systems and devices for managing data about persons and objects in a manner that is persistent, consistent with restrictions on information associated with those persons or objects, and capable of dynamically sharing data, processing tasks, tracking tasks and retrieving data in a manner that is in compliance with privacy, legal, and other requirements. The systems, methods and devices of the present invention may also enable each device to gather sufficient data about proximate real world objects to meet the tracking, identification, and data acquisition needs of AR.

These and other advantages of the present invention will become readily apparent from the detailed description below.

### BRIEF DESCRIPTION OF THE DRAWINGS

Various non-limiting embodiments are further described with reference to the accompanying drawings in which:

FIG. 1A schematically illustrates a one-to-one relationship between a user and a Digital Person Device, according to an embodiment of the present invention.

FIG. 1B schematically illustrates multiple users associated with one Digital Person Device, according to an embodiment of the present invention.

FIG. 2 schematically illustrates a Digital Class comprising a Digital Professor Device and a number (N) of Digital Person Devices, according to an embodiment of the present invention.

FIG. 3 schematically illustrates a system for managing information about living beings and/or objects, comprising a Digital Professor Device, two Digital Person Devices, and various sensors and objects, according to an embodiment of the present invention.

FIG. 4 schematically represents a typical system for managing information about living beings and/or objects comprising a first Digital Person Device, two data sources and a second Digital Person Device, operably coupled to the first Digital Person Device, according to an embodiment of the present invention.

FIG. 5 schematically illustrates a method for managing information about living beings and/objects, according to an embodiment of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications, and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. These conventions are intended to make this document more easily understood by those practicing or improving on the inventions, and it should be appreciated that the level of detail provided should not be interpreted as an indication as to whether such instances, methods, procedures or components are known in the art, novel, or obvious.

The detection and understanding of environmental elements, such as humans and other living beings, and objects, may be a challenge to programmers and hardware designers, but it is a problem that has faced living beings since the evolution of the brain. Humans, for example, are incapable of perceiving, identifying, locating, analyzing, and understanding one hundred percent of the environmental elements that surround us. Through the use of language, stored knowledge (everything from cave paintings to massive computerized databases), and task sharing (e.g., one person looks for threats while the other gathers food), humans have partially and imperfectly addressed these limitations.

Utilizing augmented reality (“AR”) technology and other computing, networking, and sensor technology, the instant invention solves the problem of detecting and understanding environmental elements in a variety of ways. It should be appreciated that the solutions herein far exceed, and differ substantially from, biologically adaptive behavior, and in some aspects require computing, networking and processing capacity well in excess of that which biological brains are capable.

In the analysis of the present invention, defined terms descriptive of what may be more common uses of the invention are utilized. These terms and their definitions are not intended to be limiting and, in fact, elements of the inventions may extend beyond the common understanding of the terms as defined. It should be appreciated that the definitions themselves describe aspects of the inventions, although there are many other aspects, and the definitions are to be understood as non-limiting.

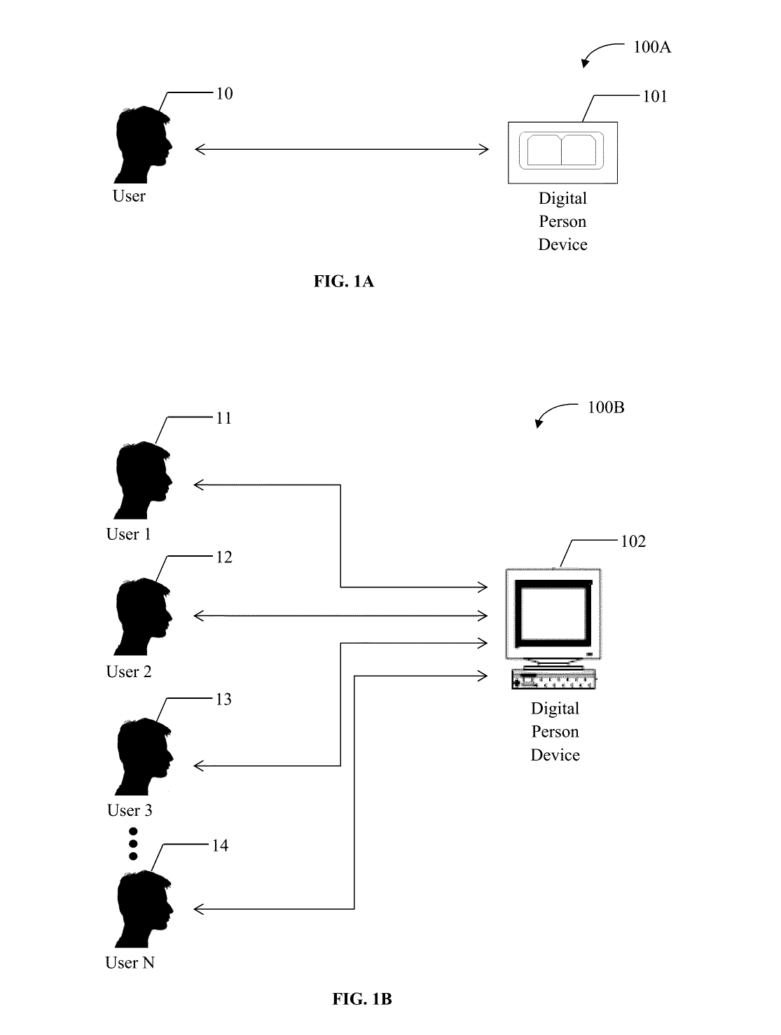

A Digital Person Device refers to a device that aggregates data, whether gathered first-hand or by a query to one or more other devices. Typically, a Digital Person Device is associated with a single user (a human being) in a one-to-one relationship (e.g., as one might expect when a Digital Person Device is utilized as a data source for augmented reality). A one-to-one relationship between a user and a Digital Person Device is shown schematically in the system 110A of FIG. 1A, wherein user 10 is associated with Digital Person Device 101. The Digital Person Device 101 may be any device capable of gathering and aggregating data such as smartphone, a personal digital assistant (PDA), a tablet, a notepad, a laptop, a personal digital assistant (PDA), or other devices, such as wearable ubiquitous computing devices (e.g. Google Glass®), etc.

However, a one-to-one relationship is not required. Indeed, there are situations where a Digital Person Device may serve as a repository for storing, sharing, or exchanging data between a plurality of users, where those users may be limited to a group with common characteristics (e.g., employees of a certain company, a group of friends, etc.). Referring now to FIG. 1B, a system 100B is shown schematically, wherein a Digital Person Device 102 is associated with a plurality of users 11-14. In the embodiment of FIG. 1B, any number (N) of users may be associated with the one Digital Person Device 102.

A Digital Professor Device refers to a device that serves as a repository for storing, sharing, or exchanging data between a plurality of users, where those users are limited to a group with common characteristics. A Digital Professor Device may generate data, receive data, repackage data, and/or share data, and may be any device capable of gathering and aggregating data such as smartphone, a personal digital assistant (PDA), a tablet, a notepad, a laptop, a personal digital assistant (PDA), or other devices, such as wearable ubiquitous computing devices (e.g. Google Glass®), etc.

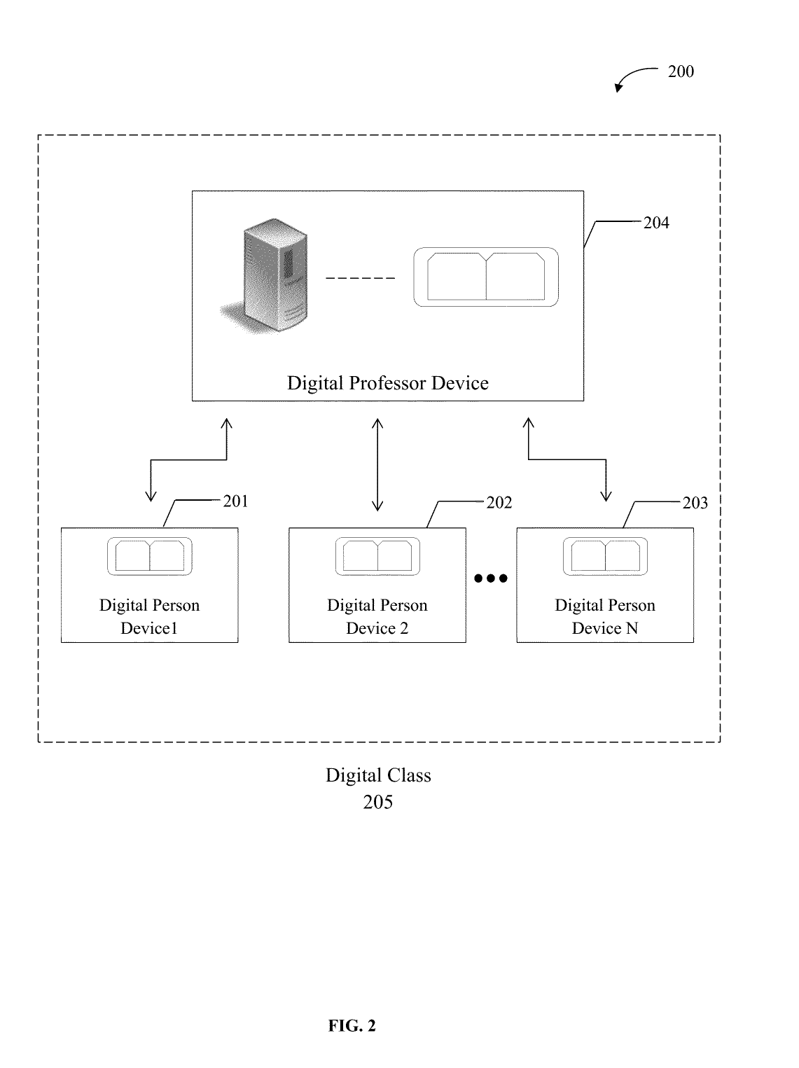

A Group of one or more Digital Person Devices in communication with a Digital Professor is referred to as a Digital Class. A Digital Class 205 is schematically illustrated in the system 200 of FIG. 2. In FIG. 2, a number of Digital Person Devices 201-203 are all associated with Digital Professor Device 204. Any number N of Digital Person Devices may be associated with Digital Professor Device 204, and may be part of the Digital Class 205.

A Self-Identifying Object is an element in the environment that is intended to be discovered (e.g., a RFID tag, a WiFi hotspot, a Bluetooth, etc.). A Unique Self-Identifying Object is a Self-Identifying Object that broadcasts data intended to allow it to be uniquely identified.

A Broadcasting Object is an element that broadcasts identifying data for purposes other than being discovered (e.g., a cellular phone, a radio station, nodes on a wireless alarm, etc.). A Unique Broadcasting Object is a Broadcasting Object where the identifying data of is normally unique (e.g., a wireless network MAC address). Although it is possible to clone a MAC address, and new technologies, such as quantum computing, make it impossible to state definitively that an object can broadcast a unique identification code in a manner that cannot be cloned; this problem may be addressed in the design of the algorithms described in this document. Furthermore, the problem may be ameliorated in whole or in part by utilizing the tracking technologies described herein to persistently track the identity of an object so that alteration to a characteristic of that object may be apparent.

An Ambient Object is an object that broadcast data that does not allow for identification of the object to the level desired by the Digital Person. For example, a circuit board may be identified as an object generating heat by use of forward looking infrared (FLIR) technology, but the combination of the data generated (e.g., the heat) and the available sensor (e.g., the FLIR sensor) may be insufficient to tell a Digital Person Device the size of the object. If object size was a desired data point, the circuit board would be, with respect to object size, an Ambient Object.

Any environmental objects, including Self-Identifying Objects, Broadcasting Objects, or Ambient Objects, may gather data and make it available to a Digital Person Device. In one scenario, a sensor (e.g., a digital camera) would gather environmental data and make it available to one or more Digital Person Devices by broadcasting the data. However, it should be noted that even an Ambient Object may be a data source. For example, a human that walks barefoot across a tile floor leaves footprints (e.g., highly transient heat footprints, highly persistent dirt footprints, or otherwise). The tile floor is thus a source of data with regard to the other object, specifically, the person who crossed the floor.

A Sensor is any object that contains data. In many cases, a Sensor may also generate data. Examples of Sensors include, but are not limited to, terrestrial/RDS/satellite radio sensors, pressure sensors, temperature sensors, humidity sensors, NFC communications sensors, and/or barometric pressure sensors. A Controlled Sensor is a sensor (e.g., a video camera) that may be controlled by a Digital Person Device capable of exerting control. While the term Sensor in this document is used primarily to refer to a dedicated sensor (e.g., a device designed to sense and report data), it should be understood that embodiments of the invention herein may utilize any Sensor. In some implementations humans may serve as a Sensor and/or may directly instruct a Digital Person Device as to the identity, location, or some other characteristics of an object.

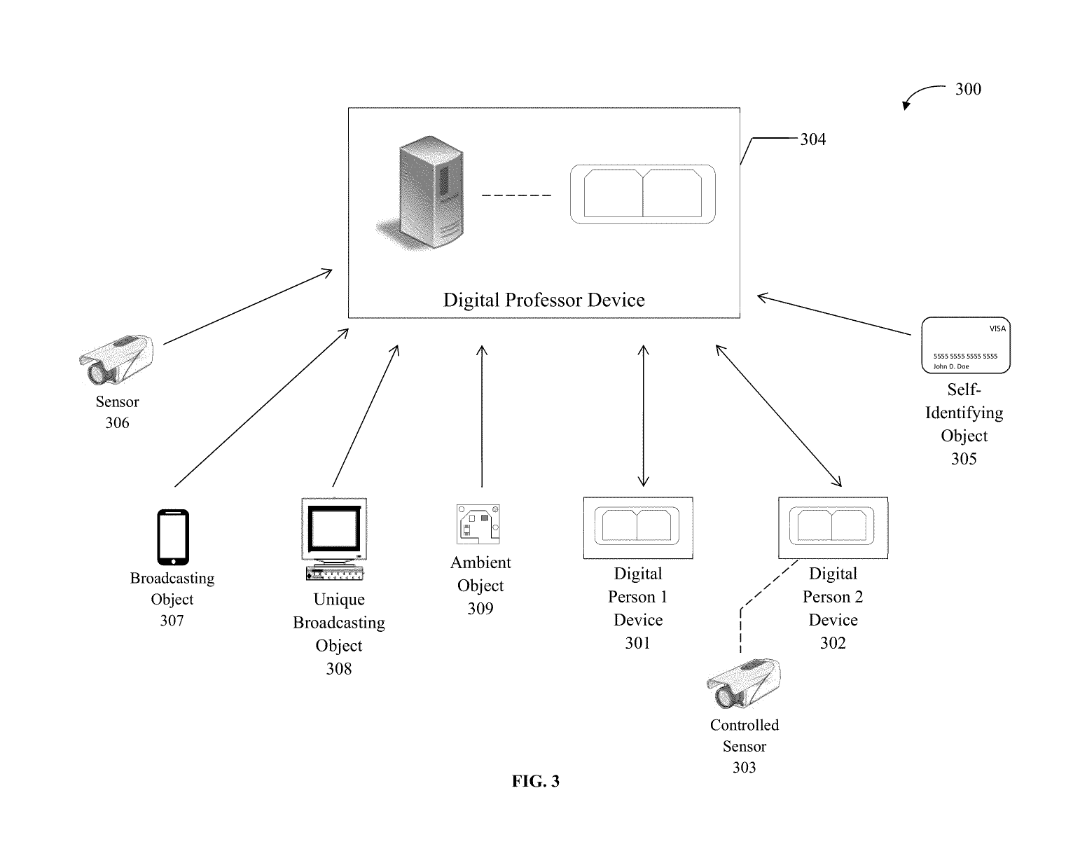

Referring now to FIG. 3, therein is shown a schematic illustration of a system 300 for managing information about living beings and objects, tracking and identify persons and objects, and managing and sharing data about persons and objects. In the embodiment of FIG. 3, system 300 comprises a first Digital Person Devices 301, a second Digital Person Device 302 with associated Controlled Sensor 303, Digital Professor Device 304, Self-Identifying Object 305, Sensor 306, Broadcasting Object 307, Unique Broadcasting Object 308, and Ambient Object 309. Although the embodiment of FIG. 3 comprises one Digital Professor Device 304 and two Digital Person Devices 301 and 302, system 300 may comprise any number of Digital Professor Devices and any number of Digital Person Devices. Similarly, the embodiment of FIG. 3 comprises just one Controlled Sensor 303, one Self-Identifying Object 305, one Sensor 306, one Broadcasting Object 307, one Unique Broadcasting Object 308 and one Ambient Object 309. However, in other embodiments, a plurality of Controlled Sensors, Self-Identifying Objects, Sensors, Broadcasting Objects, etc., may be utilized.

Possible aspects of the present invention include (among others): (i) allowing a persistent, high data density representation of a venue to be generated and tracked over time regardless of the persistence of any particular devices in the venue or the computing or perceptual limitations of any particular device, thereby enabling public safety personnel and/or others to use augmented reality devices to see and hear through walls or other barriers; (ii) enabling human corrections to errors in object identification to be shared in a persistent manner between devices; and (iii) enabling devices to identify which objects or features in a venue are important and for what reason (e.g., by identifying objects that are of high interest to a particular affinity group). These aspects, and others, are detailed below.

In one aspect, Digital Person Devices do algorithmically something loosely similar what mammals might do when walking into a new setting. A human walking into a room will scan the room for friends or family, will evaluate the state of the other humans (e.g., if the other humans are all in a state of panic, it is an indication that the human walking into the room should quickly exit), and will then seek to exchange data with other humans (e.g., by seeing a friend in the room and asking the friend “what is going on here?”).

In embodiments of the present invention, Digital Person Devices may be programmed to communicate in a way that respects limitations on data sharing in a manner analogous to how humans behave. Just as a human can tell what the primary object of interest is when entering a room where people are looking in the same direction, so too would a Digital Person Device be able to gather the most important ambient data by utilizing trusted relationships with other Digital Person Devices.

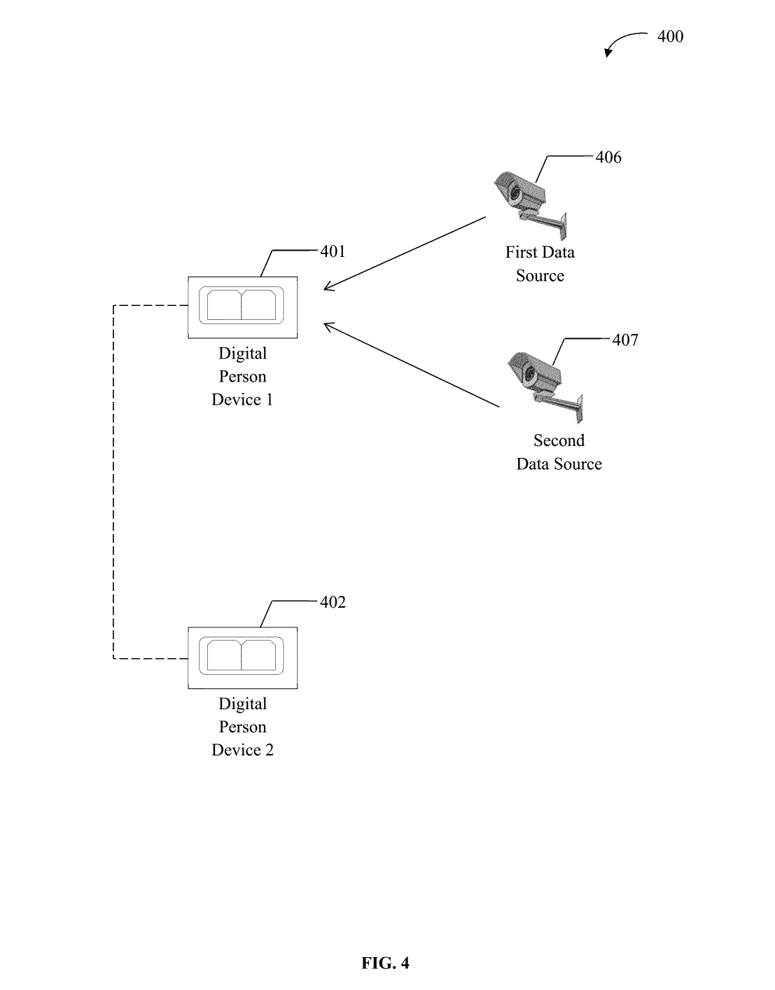

Typically, implementations of the present invention involve at least two Digital Person Devices and at least one data source. FIG. 4 schematically illustrates a typical implementation of a system 400 for managing information about living beings and/or objects. In the embodiment of FIG. 4, a first Digital Person Device 401 gathers and/or aggregates data from first and second data sources 406, 407. In the embodiment of FIG. 4, the first and second data sources are cameras. However, data sources may be any number of different types of devices including, but not limited to sensors, broadcasting objects, unique broadcasting objects, self-identifying objects, ambient objects, etc., as described above.

As shown in the embodiment of FIG. 4, the first Digital Person Device 401 is operably coupled to a second Digital Person Device 402. The second Digital Person Device 402 may obtain and/or analyze the data gathered by the first Digital Person Device 401. The amount of data shared by the first Digital Person Device 401 with the second Digital Person Device 402 may be based on privacy, legal, contractual and/or policy restrictions. In general, Digital Person Devices may be programmed to obtain and/or analyze data in part by using observations and/or analysis done by other Digital Person Devices, in a manner similar to how humans use communication and learning to save from having to personally observe and parse all ambient information.

However, embodiments of the present invention go far beyond a digital version of how humans approach data sharing. Computers are capable of quickly and securely establishing and maintaining complex data sharing arrangements, so a new Digital Person Device entering an environment expands the observational power of the other associated Digital Person Devices by nearly the full amount of power of the new Digital Person Device. Instead of wasting time re-observing things that other Digital Person Devices have already identified, as a human might do, the Digital Person Devices may instead allocate the remaining unidentified living beings and/or objects among each other for more rapid identification.

Similarly, the time that identification data persists is potentially infinite, so long as at least one Digital Person Device continues to track an identified object long enough to hand that object off for tracking to another Digital Person Device. A single device can track a substantially larger number of digital objects that have already been identified than may be tracked if the device was simultaneously trying to track and identify an entire room of new objects.

While operating as an accurate analogy for a subset of aspects of the present invention, one might imagine, in the context of human beings, that it would be as if a person could walk into a room and immediate share the relevant memories of one or more people already in the room as well as memories those people have obtained from other people who previously left the room. Further, it would be as if each person entering the room was able to see through any set of eyes in the room and hear via any set of ears in the room.

Even further yet, it would be as if the humans could split the tasks of watching parts of the room without experiencing a material lag in time in receiving results of other humans engaged in watching other portions of the room. While humans are not biologically capable of creating a dynamic perceptual cloud data sharing and analysis solution in this manner, aspects of the present invention utilize computing devices to do so.

Once identified, specific characteristics of a living being and/or an object may be measured, making it easier to identify the living being and/or the object in the event that tracking fails. For example, if John Doe is wearing a red “USPTO” sweatshirt and he goes to a bathroom where there are no sensors, a single device, or multiple devices acting in concert and/or sharing information, might receive sensor data after John Doe leaves the bathroom that would identify him as John Doe with only a 40% confidence level. However, the data about the sweatshirt and his last known location before John Doe entered the bathroom may match the new sensor data after he leaves the bathroom, raising the confidence level to 98%. Where the cloud of devices extends beyond a single location, sharing of additional contextual, current and/or other newly acquired identifying data, whether transient or otherwise, may be utilized.

It should be appreciated that humans, whether the operator of the device or otherwise, may be queried by the device in order to improve identification and tracking By presenting one or more “best guesses” to a person, the chance that the person will correctly identify the person or object is improved. In one example, the device may ask the device owner “I think that is Abe, but it is possibly Bill. Do you know who it is?” In some aspects, the response may become persistent data subject to the rules and mechanisms described herein.

In some instances, a person may become a Self-Identifying Object or may provide identifying data. For example, if a person walks up to another person and says, “Hi, I'm Jane Doe”, a sensor may detect that sentence, may convert it to text or another representative data format, and may utilize it as additional identifying data. Similarly, a person thumbing through their wallet or pulling out a credit card or driver's license may be identified by imaging and/or analyzing that item (e.g., “analyzing” an item without imaging it may be reading an RFID signal from the item).

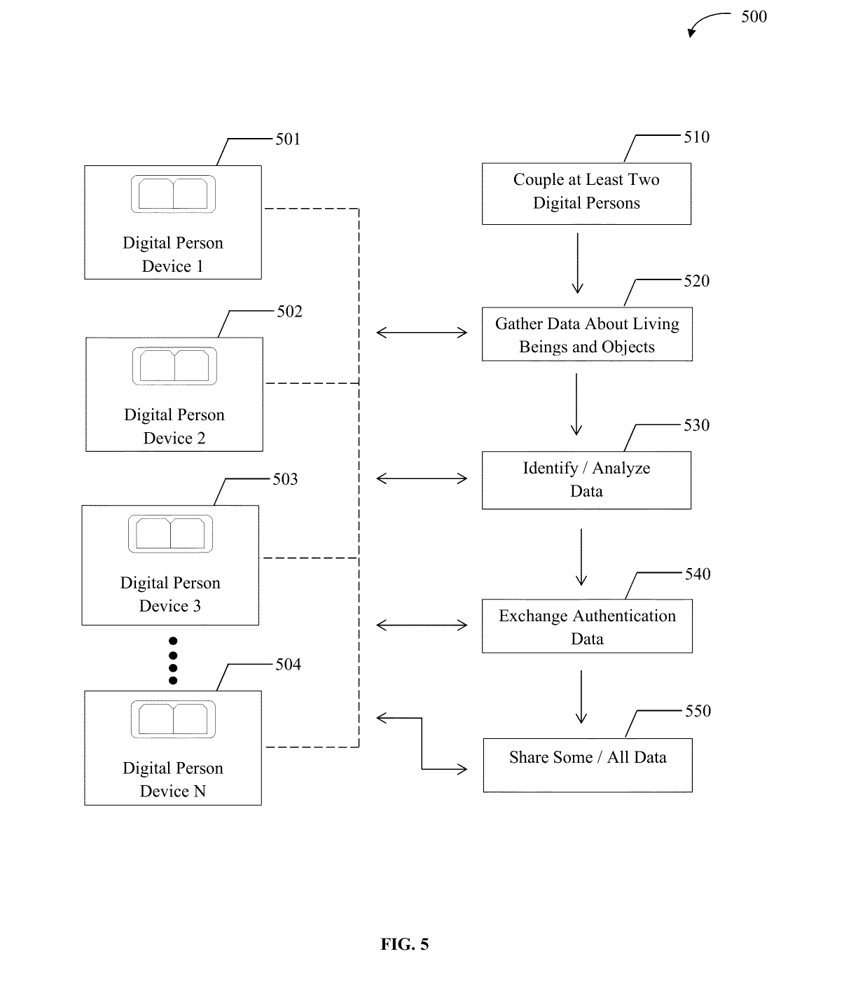

Embodiments of the present invention also provide methods for managing information about living beings and/or objects so as to improve qualities and/or quantity of available data to Digital Person Devices. Referring now to FIG. 5, an exemplary method is schematically illustrated. In the embodiment of FIG. 5, a number (N) of Digital Person Devices are shown. At step 510, the N Digital Person Devices are operably coupled together. Such coupling may be achieved directly, over a near field network (e.g., a Bluetooth), a local area network, (e.g., a Wi-Fi network), a cellular network, a wide area network, or otherwise.

At step 520, data us gathered and/or aggregated about living beings and/or objects. Such data may be gathered by one or more of the Digital Person Devices 501-504 from sensors, broadcasting objects, unique broadcasting objects, self-identifying objects, ambient objects, etc. (not shown), as described above. At step 530, the gathered data is identified and/or analyzed. Such identification and analysis may be performed by one, more than one, or all of the Digital Person Devices 501-504. At step 540, the Digital Person Devices 501-504 may exchange authentication data to determine the types of gathered data that may be shared with the other

Digital Person Devices 501-504. Based on the authentication data, at step 550, some or all of the gathered data may be shared.

In embodiments of the present invention, one of the benefits is that information obtained by one device can be utilized by a plurality of devices, even if the device that originally obtained the information is no longer available and/or if the device that originally obtained the information is no longer tracking or in the same location as the target. In an imperfect analogy of an aspect of the invention, this may be understood as a peer-to-peer network of devices with distributed data storage, processing, sensors, and/or sensor analysis. In some implementations, it may be desirable to use a Digital Professor Device to serve as a reliable point of data retrieval and storage, to coordinate data collection and updating tasks, to ensure data integrity, to update data itself, etc.

In one aspect, a Digital Professor Device may be utilized in a manner akin to a database. The Digital Professor Device may be a single device or a plurality of connected and/or coupled devices. Additionally, the Digital Professor may create additional copies of itself. For example, when a member of a four-server cluster becomes disconnected, the disconnected member and the remaining three-server cluster may each move forward with a full copy of the data. The Digital Professor Device may be physically located proximate to the Digital Person Devices connected and/or coupled to it, but need not be physically proximate.

In one aspect, the value of the data may be recognized through a payment and/or exchange program. For example, a company may operate a large number of cameras coupled (e.g., directly, over a network, etc.) with computers that are programmed to perform object recognition and tracking. The company may sell access (e.g., on a subscription, micropayment, ad-hoc or other basis) to raw data and/or to processed data and/or to the conclusions derived from the data (e.g., the identity of a person or object being tracked, in some cases in conjunction with the history and/or current location and/or activities). The company operating the camera may place a Digital Person Device or Digital Professor Device in various locations to distribute such data to members or subscribers, and/or to sell such data.

In some embodiments, the method may also comprise programming Digital Person Devices with rule sets as to when and for how much they should purchase data, and what kinds of parameters (e.g., price, data type, data age, historical data accuracy, availability of data from other sources, etc.) may be used in such a determination. The data may be also cryptographically secured in a manner that prevents unauthorized redistribution.

In another aspect, a portion of the data may be cryptographically secured, but a second portion (e.g., a portion identifying a task of tracking a person or object that the remaining cryptographically secure data relates to) may be capable of transfer without security or with a different security scheme. The second portion may also contain data indicating where to locate the related cryptographically secured data or may have the cryptographically secured data appended to the non-secured and/or differently secured related data.

In another aspect, the method may comprise data sharing and use of assistive devices, such as augmented reality devices (e.g., Google Glass®, a tablet, etc.) to “see” around corners, hear sounds from a greater distance, or otherwise enhance perception of data as if they were closer to the data source.

Apparatuses for seeing through walls and/or other opaque barriers may comprise at least one imaging device (e.g., a video camera) located behind a wall or other opaque barrier, and at least one receiving device (e.g., a wearable display device, a projection device, etc.) located in front of the opaque barrier. The imaging device(s) and the receiving device(s) may be operably coupled to a data processing device, which may analyze data from the imaging device(s) and display on the receiving device(s) all or a portion of the data imaged. The display of data on the receiving device(s) may overlay a portion of the data on the receiving device(s) such that at least a portion of the opaque barrier appears to a user of at least one of the receiving devices to be transparent. In a simple example, a network-accessible camera may be utilized to image a room, and a person in an adjoining room using augmented reality glasses may, in a virtualized manner, “see through” the wall (e.g., by presenting the wall as semi-opaque, placing a virtual window in the wall, etc.).

In some aspects, the imaging devices and/or the receiving devices may provide location data to the data processing device, and the data processing device may utilize the location data provided to accurately display visual data to appear as if the opaque barrier is at least semi-transparent. In some aspects, two or more imaging devices may be located behind the opaque barrier, and the processing device may synthesize visual data to make it appear as if the synthesized visual data was generated by an imaging device located from a point of view different from the point of view of actual imaging devices. The receiving devices may then display the synthesized visual data as if the receiving device was looking through the opaque barrier at actual objects represented by the synthesized visual data.

In some embodiments, data from the imaging devices are only made available to authorized receiving devices, and a lower and/or degraded level of accuracy may be provided to a receiving device not authorized to receive a greater level of accuracy. In some embodiments a passkey or other code may be utilized to determine which receiving devices are authorized to receive a high level of data.

In some instances the display device may be a sighting device on a firearm. In such instances the locations of building elements (e.g., studs, concealed electrical boxes, fire stops, etc.) may be determined (e.g., by infrared imaging, imaging based on sound waves, magnetic sensing, etc.) and the operator of the firearm may be signaled when the firearm is pointing at a building element that may interfere with the travel and/or trajectory of a bullet through the wall.

In another example, a person listening to a speaker may utilize the microphone of one or more devices proximate to the speaker in order to obtain a stronger or less noisy sound from the speaker. It should be appreciated that the method may also comprise signal processing to alter the perspective of the data and/or to combine a plurality of data streams. For example, a room with cameras in each of the corners may provide data to a Digital Person Device which, in turn, synthesizes the data and presents a view to the user that appears as if the user is viewing the room, through the wall, from the user's then-current position, even if there is no camera capturing data from that specific angle or location.

Using the embodiments disclosed herein, the invention may be massively scaled, if desired. For example, each of a group of police in charge of securing a venue for a speech by a politician may utilize a Digital Person Device, and each Digital Person Device may connect to one or more Digital Professor Devices and/or Digital Person Devices in order to create an accurate and effectively real-time image of the full venue. If, for example, numerous persons were utilizing wearable Digital Person Devices (e.g., glasses in the style of Google Glass®), a condition of accessing the venue may be requiring the Digital Person Devices of attendees to share visual and audio data with police Digital Person Devices. In such circumstances, if a gunshot were heard coming from a restroom, each of the police at the venue may look through the interceding walls directly into the restroom and see events happening in real time or near real time.

In one aspect, such data may have substantial public safety benefits. For example, a police officer may shoot a terrorist through a wall, based on a synthesized view through the wall. Data related to the composition of the wall and the likely path of a bullet may, in this example, be drawn from databases such as a blueprint database at the government office that issued the building permit for the structure, and/or public databases and/or other private or government databases. Similarly, the results of an initial shot may be utilized to correct the view and predictions presented to the officer immediately after the results of the shot are imaged by devices inside of the room.

In one aspect, data sharing and persistence is governed by certain rules. In another aspect, the permissions travel at least in part with the data, optionally where the data is cryptographically or otherwise secured and made accessible or readable only when the permissions conditions are met. The permissions may be related to classes of data, classes of relationships between the operators of the devices, classes of relationships between the owners of the devices, the nature of the data, or other criteria.

As an illustration, consider a room with the following people, who enter the room in alphabetical order: (1) Abe, an employee of Patent Co.; (2) Beth, an employee of Patent Co. and a friend of Charles; (3) Charles, a friend of Beth and Dave; (4) Dave, a friend of Charles; (5) Earl; (6) Fred, a police officer; (7) Gail, a police officer; (8) Helen, a fire fighter; and (9) Ian, a federal marshal. There are several sensors in the room. Each person has a head-mounted sensor system (e.g., Google Glass®) and a smart phone. There is a police security camera mounted outside of the room. There is a Patent Co. camera mounted in the room.

When Abe enters the room, his system uses his sensor and the Patent Co. camera (which his system has rights to access), and identifies the thermostat and other items in the room as well as noting that Abe is in the room. Abe's sensor did not have a GPS fix when he entered the room. When Beth enters the room, her device interfaces with Abe's device (and with the Patent Co. camera). Abe's device may conduct verification of Beth's device (e.g., by checking for a specific cryptographic signature or code, doing facial recognition on Beth and comparing that to the device, exchanging keys, and/or by other means). Abe's device then determines which rules apply to data and task sharing with Beth's device. In this example, it may identify “public” and “co-worker” rule sets. Under the “public” rule set, it makes certain data available (e.g., the location of the thermostat). Under the “co-worker” rule, it makes other data available (e.g., verification of Abe's identity, how long Abe has been in the room, information about all objects in the room, the last ten minutes of data from the Patent Co. camera, and the time of Abe's next appointment). Beth's device does a similar check and then shares GPS data with Abe's device, together with certain information about Beth.

The information learned from Abe's device is, in one aspect, correlated with rule set data. For example, the time of Abe's next appointment is marked “not shareable” and will not be retransmitted by Beth's device under any circumstances, while the thermostat's location is marked “freely share” and can be retransmitted under all circumstances. In one aspect, the data limitations may be enforced by cryptographically secure storage subject to confirmation of permission to transfer. In other aspects, the limitations may be enforced by locally encrypted storage and a remotely controlled decryption key or, in yet other aspects, by transfer of data in an encrypted state that must query a machine affiliated with Abe to obtain the decryption key.

Charles enters the room and queries Beth's device and Abe's device. Abe's device shares only public data with Charles' device. Beth's device shares all of its own data available under a “friend” rule, together with any data obtained from Abe's device that is subject to a rule that permits sharing with a “friend” of Beth. Beth's device identifies Charles and, because it has identified it without reference to permissions-limited data, shares that identification with Abe.

Dave enters the room and the data sharing continues based on the rule sets as described. When Earl enters, his device does not provide identification information because he has set its rules up in that manner. Public data is shared by the other devices in the room, but data that is conditioned on sharing only with identified persons' devices is not shared. Because Earl is not identified yet, the devices owned by Abe, Beth, Charles and Dave negotiate with each other based on the reciprocal trust relationships, whereby each of Abe, Beth, Charles and Dave is connected through not more than N number of connections of acceptable types. Abe's device is tasked with utilizing the camera data and visual data from the other devices to measure facial metrics; Beth's device measures voice tenor and cadence; Charles' device tracks Earl's movements and watches for potential threats, such as a gun or a threatening stance; and Dave's device coordinates the gathering of the data from the other devices, transmission to and from servers, and searches of databases in order to obtain an identification based on the gathered data.

Once Earl's identity, likely identity, or identity plus a confidence level associated therewith is established, it is stored within one or more of the devices in the room and, if the negotiated rules between the devices so stipulate, sharing rules may be associated with the identity data. In the event that sharing rules are so associated, one or more of the devices may utilize only data gathered by a subset of the devices and obtain an identity (or identities) together with a confidence level, and that identity would then be governed by different sharing rules. To illustrate, if the rule about identity negotiated between all four devices is “no sharing outside of friends”, the devices Abe and Beth have may continue to attempt to identify Earl, even after his identity is established by the four devices in concert, and if they can identify Earl without reference to Charles' or Dave's device or data obtained from them, then Earl's identity and confidence level associated with that, as determined by Abe's and Beth's devices alone, may be stored and made available for sharing to anybody associated with Patent Co. regardless of the number of devices the data passes through. The multiple identifications of a person or entity with different associated sharing rules may be combined where the rules so permit, such as in a case where a friend of Beth who also works for Patent Co. joins the group.

When Fred and Gail enter the room, their devices identify them as law enforcement. The rule sets relating to law enforcement (or a specific law enforcement agency) are applied. In one aspect, the rules are automatically modified by reference to a database or other data source relating to legal restrictions on data sharing. Such modification may be well illustrated in the context of law enforcement, but is not so limited. Using law enforcement to illustrate this modification, Fred's device queries the Patent Co. camera and asks for past data. Patent Co. has designed rules for its camera that require a warrant for data sharing with law enforcement except in exigent circumstances where a warrant would not be legally required for a search. Patent Co.'s camera refuses to share data with Fred or Gail. The sharing rules for Abe's and Beth's identification of Earl, however, do permit warrantless sharing with law enforcement. Fred's device, upon receipt of the identification of Earl, references a database and determines that Earl is an escaped felon who is believed to be armed and dangerous. Fred's device then sends the data to a device and/or person who applies for and/or obtains and/or issues a search warrant, the warrant data is transmitted to the Patent Co. camera, and the Patent Co. camera releases its data to Fred and Gail.

Alternatively, it may be determined that Earl's presence is an exigent circumstance and a request made to the Patent Co. camera, without a warrant but with a certification of exigency, for data related to Earl. The Patent Co. camera may then release all data or a subset of data, for example, the subset where it has captured Earl's image. In one aspect, the sharing restriction may be set such that data is only released to persons and/or to other devices where the devices analyzing the data determine that they have relevant data (e.g., data related to exigency, subject to a search warrant and/or relevant to a search warrant). For example, the Patent Co. camera may transmit data to other Patent Co. devices and/or analyze the data itself looking for evidence that Earl has a weapon. When fifteen seconds of video are identified where the outline of a gun is visible in Earl's pocket, that data is shared with Fred and Gail.

Fred may then pull out a weapon and tell Earl “freeze”. Earl may grab for his weapon, have the weapon discharge harmlessly once and then jam. Gail may then handcuff Earl. At this time, Helen, the firefighter/paramedic, is outside and hears the gunshot. Her device certifies exigent circumstance to other devices. Her device then obtains video from inside of the room, such as video from all of the participant's heads-up devices and the video camera. The camera outside the room simultaneously transmits to Fred and Gail the image of Helen.

In one aspect, Helen may experience an image on a heads-up display wherein the wall becomes semi-transparent or invisible and she is able to see through the wall to the actual scene inside. Such image may be a composite of a plurality of images captured from a plurality of devices. In one aspect, the image may be reconstructed from a perspective that appears as if Helen is looking at the scene with her own eyes. In one aspect, such reconstruction may be made with interpretation and interpolation from a small amount of data, such as that from a single camera. In another aspect, a light field camera (such as the Lytro™ Camera) may be utilized as one of the data sources and a reconstruction made by analysis of photon/light field data, combined optionally with other data.

Taking the example a step further, imagine Ian, the federal marshal, is called to the scene. Ian's device performs a verification of all of the devices at the scene. Fred, Gail, and Helen's devices all share the totality of their data with Ian's device. The other participants' devices and the cameras share data pursuant to the relevant sharing rules. Everybody except Earl and Ian leave the room while Earl is handcuffed. When Abe returns to the room later, data stored within the Patent Co. camera device may be shared with Abe, and depending on the rules that governed the data that the Patent Co. camera device obtained, such data may include the location of objects in the room and/or the identities of Earl and Ian. Similarly, Ian's device may have received data from Abe's device and potentially other devices. Some of the data may have been marked as unsuitable for sharing with Ian, but the devices may have a rule set that permits a data persistence agreement whereby Abe's data is saved (in one aspect, in an encrypted fashion not accessible to Ian) on Ian's device. Abe may then leave the room again and Beth may enter. Beth's device may query Ian's device and obtain any data that it is permitted (per the rule set) to access, including encrypted data that Abe's device stored in Ian's device. In one aspect, Beth's device may query Abe's device or another device over a network in order to obtain a decryption code. In another aspect, Beth may have a decryption code in her device capable of decrypting data falling under a certain Patent Co. rule set.

In one aspect, even when a device such as Ian's device is not permitted to access a portion of the data, for example, the identity of Abe, it may nonetheless continue to track the person or item associated with that encrypted data, and/or may hand off the tracking duty to one or more other devices, such as in a case where Ian's device leaves the room. Thus, Ian's device may not know Abe's identity, but when Beth enters the room, Ian's device would know the then-current location and, in some cases, subsequent or other acts or information about a person or object associated with the encrypted data set that is related to Abe. Since Beth's device can decrypt the data, Beth's device is able to associate that person or object and any additional related information to Abe.

In some cases, it may be desirable to associate payments, whether financial or denominated in computer time, device time, or other related resources, with activities. Priority levels may also be established, and may optionally be associated with or related to payments. Thus, for example, Patent Co. may have a policy of setting a top priority of tracking other employees of Patent Co., so if a device is unable to do all of the tasks asked of it, the task of tracking other employees of Patent Co. would not be dropped until all lower priority tasks were dropped.

In other cases, a payment may be made, a payment committed to, or an exchange of task responsibility made between devices to change priority levels. For example, Earl's device may have been programmed to charge one penny for each percent of its tracking capacity, and may thus be used as a repository for tracking tasks or storing data from other devices that are nearing or out of additional capacity. In one aspect, the integrity of devices may be verified prior to sharing data. In another aspect, data may be encrypted and only the portions necessary to the tracking task made available, either via sharing only a reference to data not actually exchanging the data or, if shared, via encryption.

In another aspect, an algorithm or other mechanism may be utilized to identify the optimal device to take over a tracking task. For example, in the case of tracking a person, a device equipped with FLIR and audio tracking may be given the task. In the case of tracking a balloon floating in a room, a camera not reliant on heat sensing may be utilized. In some cases, multiple devices may be combined and, optionally, one of the devices designated as the primary or coordinating device. In another aspect, the devices may be utilized in a redundant manner, so that a failure of one or more devices does not cause a failure to track.

In one aspect, devices may measure and/or share medical data. Such data may, in some cases, be associated with sharing restrictions, and in some cases such restrictions may be lifted or modified in the event of a medical emergency. For example, if user Joe has a heart condition and his device, which includes an EKG, detects the signature pattern of atrial fibrillation, his device may transmit the data immediately to emergency responders, may signal a nearby defibrillator to begin charging, and to identify itself to other devices in the room, may make a noise, light and/or other signal, may cause the system controlling the door lock to unlock and open the door, and/or may otherwise share the data.

In another aspect, devices may exchange medical information related to communicable diseases. For example, if Harry has not been immunized against Chicken Pox and Ida has Chicken Pox, as Harry approaches Ida's location, Harry may receive a warning. In one variation, the warning may be anonymized in a manner that does not specifically identify who has the disease or even the nature of the disease, but merely instructs Harry as to what actions to take to avoid a health risk, optionally including the magnitude and/or other details of the risk.

In one aspect, medical function may be combined with object or person tracking If Ida and related objects were tracked, even though Ida left the room two minutes prior to Harry's arrival, the device may identify objects Ida touched, compare the known persistence of the Chicken Pox virus with the time passed, and identify objects that pose a risk. Thus, for example, the device may warn Harry not to touch the pen near the phone because a Digital

Professor Device shared with Harry's Digital Person Device that Ida had held that pen within fewer than N minutes, where N is the amount of time wherein the Chicken Pox virus dies on a surface. Indeed, the tracking may be sufficiently robust that even if Ida's condition is not diagnosed at the time she touched the pen, a later diagnosis may be transmitted through the perceptual cloud and utilized to update the data related to the pen.

In another aspect, behavior and tracking of persons may be utilized to sell goods or services, to tailor goods or services to the needs of a person, and/or to otherwise commercially exploit the data. In some cases, payment in exchange for commercially useful data may be made to one or more of (i) the user, (ii) the owner one or more Digital Person Devices, (iii) the owner of one or more Digital Professor Devices, (iv) the owner of one or more sensors, and/or (v) others involved in the perceptual cloud.

In one aspect, such payment may be related to the actual value of the data, such as by providing a percentage of a sale. In another aspect, a person may create sharing rules whereby commercial use of some amount or type of data is permitted in exchange for a payment to the person. Access to shared data, processing capabilities and/or storage capacity of the person's devices are given to other participants in the perceptual cloud, and in some aspects, such payments may be made in a manner whereby the payments are at least partially shared with one or more of the participants that interacted with the data prior to the data being shared with the party making the payment.

It should be understood that one aspect of the present invention is that persons or objects may be tracked in a manner where different devices hand off the responsibility for tracking the person and/or object as the person and/or object moves through the world. With a large enough set of devices and a sufficient set of data sharing and security arrangements implemented via computer, it is possible to simultaneously identify nearly all objects and/or persons of interest, and so long as a sufficient number of people have devices that participate in the system, and so long as the sharing rules are configured in a sufficiently promiscuous manner, the ability to track persons and/or objects will scale in a manner that tracks demand.

The foregoing descriptions of specific embodiments of the present invention have been presented for purposes of illustration and description. They are not intended to be exhaustive or to limit the invention to the precise forms disclosed. Obviously, many modifications and variations are possible in light of the above teaching. The embodiments were chosen and described in order to best explain the principals of the invention and its practical application, to thereby enable others skilled in the art to best utilize the invention and the various embodiments and modifications as are suited to the particular use contemplated. It is intended that the scope of the invention be defined by the components and elements described herein and their equivalents.

What is claimed is:

1. An apparatus for imaging through opaque barriers, the apparatus comprising:
at least one imaging device located behind an opaque barrier,
at least one receiving device located in front of the opaque barrier,
wherein the at least one imaging device and the at least one receiving device are operably coupled to a data processing device,
wherein the data processing device analyzes data from the at least one imaging device and displays at least a portion of the data on the receiving device,
wherein the display of data overlays a view of at least a portion of the opaque barrier in a manner that makes it appear to one or more users of the receiving device(s) as if the opaque barrier is at least partially transparent with regard to at least one object located behind the opaque barrier.

2. The apparatus of claim 1, wherein the receiving device comprises a wearable display device.

3. The apparatus of claim 1, wherein the receiving device comprises a projection device projecting visual data on the front of the opaque barrier.

4. The apparatus of claim 1, wherein the imaging device and/or the receiving device provide location data to the data processing device, and the data processing device utilizes the location data to accurately display visual data as if the opaque barrier is at least semi-transparent.

5. The apparatus of claim 1, wherein at least two imaging devices are located behind the opaque barrier, and the processing device synthesizes visual data as if such synthesized visual data was generated by an imaging device located from a point of view different from the point of view of actual imaging devices.

6. The apparatus of claim 5, wherein the synthesized visual data is generated in a manner that permits the receiving device to display the synthetized visual data as if the receiving device was looking through the opaque barrier at actual objects.

7. The apparatus of claim 1, wherein data from the imaging device(s) is made available only to properly authorized receiving devices.

8. The apparatus of claim 1, wherein the data is of a degraded level of accuracy when provided to a receiving device that is not authorized to received data with a greater level of accuracy.

9. The apparatus of claim 1, wherein the receiving device is a sighting device on a firearm.

10. The apparatus of claim 9, wherein data about locations of building elements is utilized to signal to an operator of the firearm when the firearm is pointing at a building element that may interfere with transit of a bullet through the opaque object.

11. The apparatus of claim 10, wherein the data about the locations of building elements is generated, at least in part, utilizing infrared imaging.

12. The apparatus of claim 10, wherein the data about the location of building elements is generated, at least in part, utilizing imaging based on sound waves.

13. The apparatus of claim 10, wherein the data about the location of building elements is generated, at least in part, utilizing magnetic sensing.

14. The apparatus of claim 10, wherein the building elements comprise studs.

15. A method of imaging through opaque barriers, the method comprising:
operably coupling at least one imaging device and at least one receiving device to a data processing device, the at least one imaging device located behind an opaque barrier, and the at least one receiving device located in front of the opaque barrier;
analyzing data from the at least one imaging device;
overlaying at least a portion of the data on the receiving device such that the opaque barrier appears to a user to be at least partially transparent.

16. The method of claim 15, further comprising receiving location data from the imaging device and/or the receiving device, and displaying visual data to the user based on the location data to make the opaque barrier appear at least semi-transparent.

17. The method of claim 15, wherein one of the at least one receiving devices is a sighting device on a firearm, and the method further comprises signaling an operator of the firearm with one or more locations of building elements that may interfere with the transit of a bullet through the opaque barrier.

18. The method of claim 19, further comprising utilizing infrared imaging, sound waves and/or magnetic sensing to generate the one or more locations of building elements.

19. A method of imaging through opaque barriers, the method comprising:
operably coupling at least two imaging devices and at least one receiving device to a data processing device, the at least two imaging devices located behind an opaque barrier, and the at least one receiving device located in front of the opaque barrier;
analyzing data from the at least two imaging devices;
synthesizing the data from at least two imaging devices, and displaying visual data to the user that makes one or more objects in the visual data appear as if they are located at a point of view different from actual points of view of the at least two imaging devices.

20. The method of claim 19, further comprising generating synthesized visual data configured to allow the at least one receiving device to display the synthesized visual data as if the receiving device was looking through the opaque barrier at actual objects.
